(19) United States
(12) Patent Application Publication
(10) Pub. No.: US 2013/0139375 A1
(43) Pub. Date: Jun. 6, 2013

(54) APPARATUS AND METHOD FOR SUPPORTING CABLE AND CONDUIT

(71) Applicant: LAWRENCE REGO, Mount Vernon, NY (US)

(72) Inventor: LAWRENCE REGO, Mount Vernon, NY (US)

(21) Appl. No.: 13/311,337

(22) Filed: Dec. 5, 2011

(51) Int. Cl. F16L 3/08; B23P 11/00

(52) U.S. Cl. 29/525.11; 248/65

(57) ABSTRACT

A bracket for supporting electrical cable may include an attachment member and a cable support member. The attachment member and the cable support member may be interposed between an open end and a closed end of the bracket. A connection member may be attached to and interposed between the attachment member and the cable support member at the closed end of the bracket.

### BACKGROUND OF THE INVENTION

The present invention generally relates to electrical wiring and more particularly to electrical wiring systems in which multiple cables and/or conduits are supported in suspended configurations.

Many buildings and industrial plants require electrical distribution systems that utilize multiple cables. These cables may be collectively routed along supporting structures that may be suspended from ceilings of buildings. It is common practice to employ racks to support such cables. In a typical installation, racks may be installed along a desired route and then cables may be threaded though the racks.

Installation of racks and threading of cables through the racks may require expenditure of substantial amounts of labor.

As can be seen, there is a need for a system through which multiple cables can be installed in a suspended configuration without a need for installing racks and threading cable through the racks.

### SUMMARY OF THE INVENTION

In one aspect of the present invention, a bracket for supporting electrical cable may comprise: an attachment member interposed between an open end and a closed end of the bracket; a cable support member interposed between the open end and the closed end; and a connection member attached to and interposed between the attachment member and the cable support member at the closed end of the bracket.

In another aspect of the present invention, a bracket for supporting cable and conduit may comprise: a cable supporting bracket which includes an attachment member interposed between an open end and a closed end of the bracket, a cable support member interposed between the open end and the closed end and a connection member attached to and interposed between the attachment member and the cable support member at the closed end of the bracket to form a cable enclosure space; a conduit support bar positioned outside of the cable enclosure space; and supporting rods attached to the attachment member of the cable supporting bracket and the conduit support bar so that the supporting rods, the conduit support bar and the cable support member of the cable support bracket form a conduit enclosure space.

In still another aspect of the invention, a method for installing a plurality of electrical cables along a desired cable route in a building may comprise the steps of: attaching a plurality of open-ended cable supporting brackets to a ceiling of the building along the desired cable route; placing the cable into open ends of the brackets; and positioning threaded rods across the open ends after the cables are positioned on the brackets.

These and other features, aspects and advantages of the present invention will become better understood with reference to the following drawings, description and claims.

### BRIEF DESCRIPTION OF THE DRAWINGS

FIGS. 1 and 2 are perspective views of a cable support bracket in accordance with an embodiment of the invention;

FIG. 3 is an elevation view of the cable support bracket of FIGS. 1 and 2; and

FIG. 4 is an elevation view of a combined cable and conduit support bracket in accordance with an embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide support brackets for cable and/or conduit and a method for installing cable and/or conduit on such brackets with minimal expenditure of labor.

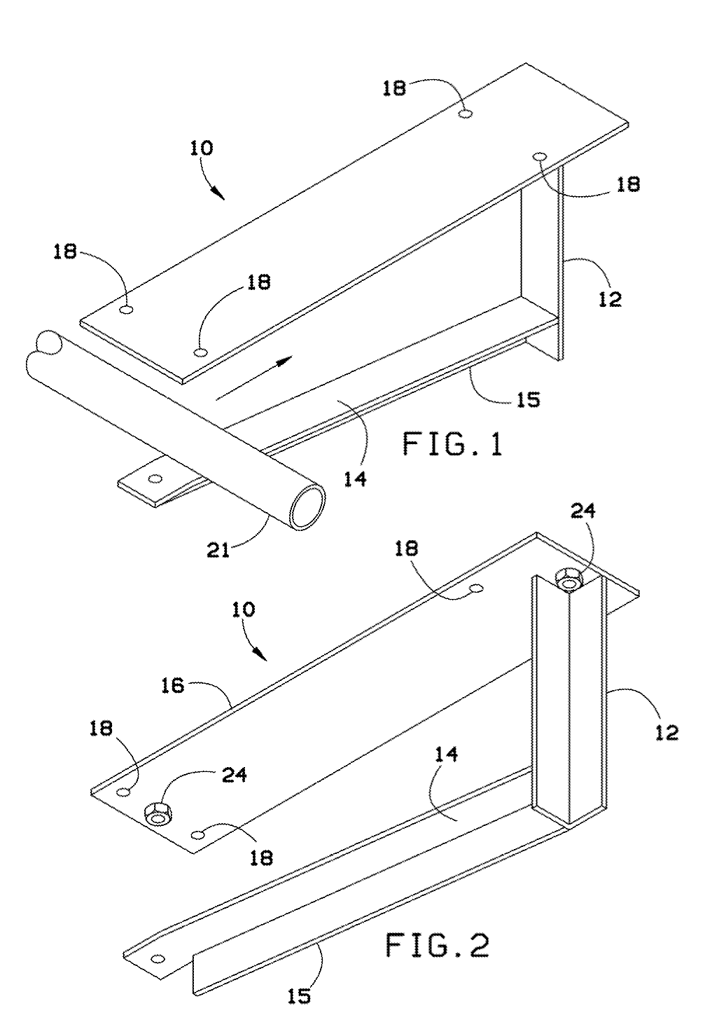

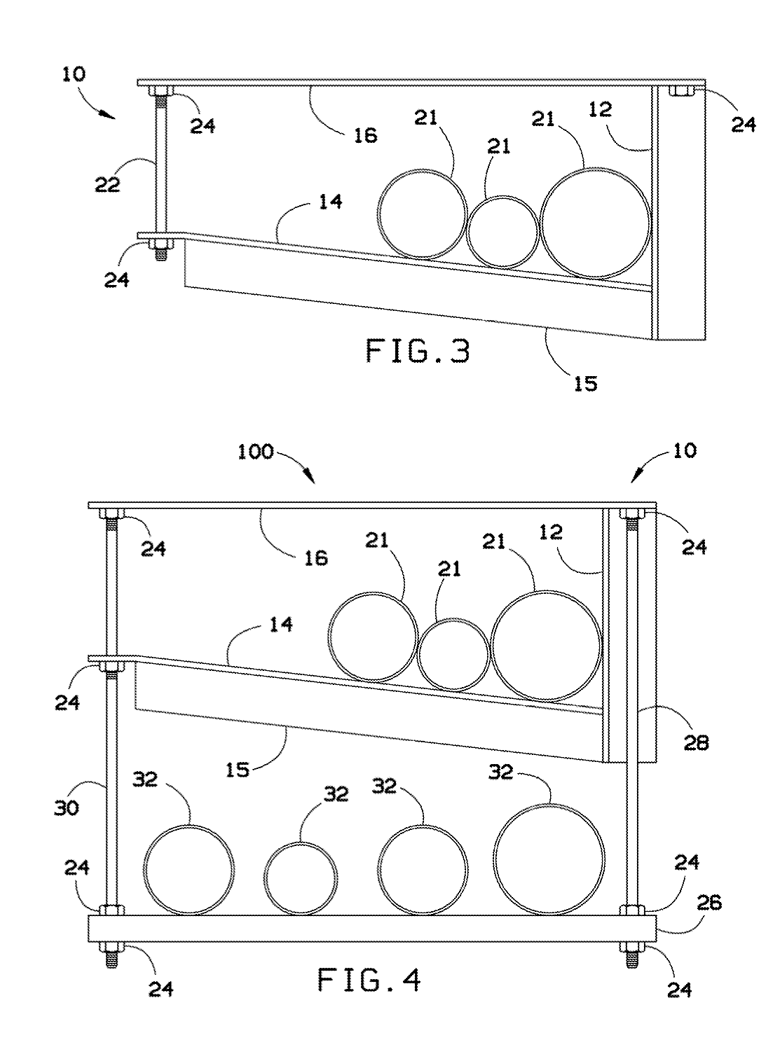

Referring now to FIGS. 1, 2 and 3, it may be seen that an exemplary embodiment of a support bracket 10 may comprise a vertical or connection member 12, a horizontal attachment member 16 and a cable support member 14. The attachment member 16 may be provided with holes 18 through which bolts (not shown) may be inserted for attaching the bracket 10 to a ceiling of a building (not shown). The connection member 12 may be welded or otherwise attached to the attachment member 16 and the cable support member 14. A stiffener bar 15 may be attached to the cable support member 14 and the connection member 12. Advantageously the connection member 12 may be constructed from angle iron. The cable support member 14 and the stiffener bar 15 may also be constructed from angle iron.

It may be noted the cable support member 14 may lie in a plane that is not parallel to a plane of the attachment member 16. In that regard, the plane of cable support member 14 may be considered to slope downwardly toward the connection member 12. In other words the attachment member 16 may be spaced apart from the cable support member 14 a first distance at an open end and a second distance at a closed end with the first distance being less than the second distance.

In operation, a number of the brackets 10 may be installed along a desired cable route in a building by attaching each bracket 10 to the ceiling of the building. After the brackets 10 are installed, a length of cable 21 may be lifted and placed onto the cable support members 14 of each of the brackets 10. The cable 21 may be slid across the downwardly sloping support member 14 until it contacts the connection member 12. A plurality of the cables 21 may be installed in this manner. As each successive cable 21 is installed; the newly installed cable may be slid into contact with the previously installed cables.

The stiffener member 15 may provide requisite rigidity so that the cantilevered cable support member 14 may support a plurality of the cables 21 without bending. Nevertheless, the bracket 10 may be provided with a threaded fastener such as a nut 24 that may be welded to the attachment member 16 so that a threaded support rod 22 may be installed after all of the cables 21. A second nut 24 may be threaded onto the rod 22 under the support member 14 to provide added supporting strength to the bracket 10.

It is important to note that cables 21 may be installed on the brackets 10 before the rods 22 are put in position. Consequently, the cable 21 can be installed without a need for threading though closed brackets.

Referring now to FIG. 4, it may be seen that a combined cable and conduit bracket 100 may comprise one of the brackets 10 and a conduit support bar 26. The bar 26 may be supported on threaded rods 28 and 30 which may be attached to nuts 24 that may be welded to the horizontal attachment member 16 of the bracket 10. The bar 26 may be used to support conduit 32 separately from the cable 21. In other words, the cable 21 may be separated a sufficient distance from the conduit to allow for conformity with regulatory code requirements that mandate separation between independent electrical systems (e.g., low voltage communications systems and high-voltage power distribution systems) The cables 21 may be in a cable enclosure space (i.e., the bracket 10) and the conduit 32 may be in a conduit enclosure space bounded by the bar 26, the bracket 10 and the threaded rods 28 and 30. Thus the cable and conduit support bracket 100 may be utilized to provide, in a single installation, a supporting system for two different electrical systems, thereby achieving substantial labor savings.

It should be understood, of course, that the foregoing relates to exemplary embodiments of the invention and that modifications may be made without departing from the spirit and scope of the invention as set forth in the following claims.

What is claimed is:

1. A bracket for supporting electrical cable comprising:
an attachment member interposed between an open end and a closed end of the bracket;
a cable support member interposed between the open end and the closed end; and
a connection member attached to and interposed between the attachment member and the cable support member at the closed end of the bracket.

2. The bracket of claim 1:
wherein the attachment member is spaced apart from the cable support member a first distance at the open end; and
wherein the attachment member is spaced apart from the cable support member a second distance at the closed end; and
wherein the first distance is less than the second distance.

3. The bracket of claim 1 further comprising a stiffener member attached to the cable support member and to the connection member.

4. The bracket of claim 1 further comprising a threaded rod engageable with the attachment member and the cable support member at the open end of the bracket.

5. The bracket of claim 4 further comprising a nut welded to the attachment member and positioned for threaded engagement with the threaded rod.

6. A bracket for supporting cable and conduit comprising:
a cable supporting bracket which includes an attachment member interposed between an open end and a closed end of the bracket, a cable support member interposed between the open end and the closed end and a connection member attached to and interposed between the attachment member and the cable support member at the closed end of the bracket to form a cable enclosure space;
a conduit support bar positioned outside of the cable enclosure space; and
supporting rods attached to the attachment member of the cable supporting bracket and the conduit support bar so that the supporting rods, the conduit support bar and the cable support member of the cable support bracket form a conduit enclosure space.

7. The bracket of claim 6 wherein the supporting rods are threaded rods.

8. The bracket of claim 7 wherein the threaded rods are threadedly attached to welded nuts on the attachment member of the cable support bracket.

9. A method for installing a plurality of electrical cables along a desired cable route in a building comprising the steps of:
attaching a plurality of open-ended cable supporting brackets to a ceiling of the building along the desired cable route;
placing the cable into open ends of the brackets; and
positioning threaded rods across the open ends after the cables are positioned on the brackets.

10. The method of claim 9 further comprising the step of pushing the cable downwardly along downwardly sloped cable support members of the brackets.
